(19) United States
(12) Patent Application Publication
(10) Pub. No.: US 2024/0328987 A1
(43) Pub. Date: Oct. 3, 2024

(54) ANALYTE SENSOR

(71) Applicant: PercuSense, Inc., Valencia, CA (US)

(72) Inventors: RAJIV SHAH, RANCHO PALOS VERDES, CA (US); BRADLEY C. LIANG, BLOOMFIELD HILLS, MI (US)

(73) Assignee: PercuSense, Inc., Valencia, CA (US)

(21) Appl. No.: 17/510,131

(22) Filed: Oct. 25, 2021

Related U.S. Application Data
(60) Provisional application No. 63/105,807, filed on Oct. 26, 2020.

(51) Int. Cl. G01N 27/327; G01N 27/30

(52) U.S. Cl. CPC G01N 27/3275; G01N 27/307

(57) ABSTRACT

In one embodiment, A working electrode configured to detect exposure to a compound of interest is disclosed. The working electrode includes a substrate that is electrically conductive along with an electrode surface disposed on the substrate. The working electrode further includes a first transport material that is disposed over the electrode surface. The working electrode also includes a first reactive chemistry disposed substantially over the electrode surface, where the reactive chemistry reacts with a byproduct generated from the compound of interest. The reaction between the first reactive chemistry and the byproduct generates an intermediary that is electrochemically reduced on the electrode surface to generate an electrical signal that is representative of the presence of the byproduct, wherein detection of the compound of interest is determined by a decrease in the electrical signal.

### RELATED APPLICATIONS

This application claims the benefit of U.S. provisional application numbers: 63/105,807 filed Oct. 26, 2020. The application listed above is hereby incorporated by reference in their entirety for all purposes.

### GOVERNMENT RIGHTS

This invention was made with government support under government contract HQ0034209PT03 awarded by the Defense Threat Reduction Agency. The government has certain rights in the invention.

### FIELD OF THE INVENTION

The present invention is generally directed to devices and methods that perform in vivo monitoring of an analyte, analytes, compound or compounds that are indicative of inhibition of neurotransmitters such as, but not limited to acetylcholinesterase. In particular, the devices and methods are for electrochemical sensors that provide information regarding the presence or amount of an analyte, analytes, compound or compounds within a subject.

### BACKGROUND OF THE INVENTION

Organophosphates and other nerve agents are capable of inhibiting the clearance of neurotransmitters. Exposure to specific organophosphates can be extremely dangerous as some organophosphates have been designed to operate as pesticides and nerve agents. Chronic low-dose exposure to inhibition agents may result in impaired neurobehavioral performance or slowed nerve conduction. Acute intoxication from exposure to specific inhibition agents can result in long lasting consequences such as intermediate syndrome or permanent disability. Severe overexposure to inhibition agents can result in sufficient inhibition of neurotransmitters leading to fatal convulsions from continuous stimulation of muscles, glands and the central nervous system. Many occupations have the potential to expose individuals to inhibition agents. Examples include many occupations within the agricultural industry, pest control industry and warfighters in an area of operations where chemical weapons may be deployed.

What is needed are real time in vivo sensing devices capable of monitoring subjects for exposure to inhibition agents.

### BRIEF SUMMARY OF THE INVENTION

In one embodiment, a working electrode configured to detect exposure to a compound of interest is disclosed. The working electrode includes a substrate that is electrically conductive along with an electrode surface disposed on the substrate. The working electrode further includes a first transport material that is disposed over the electrode surface. The working electrode also includes a first reactive chemistry disposed substantially over the electrode surface, where the reactive chemistry reacts with a byproduct generated from the compound of interest. The reaction between the first reactive chemistry and the byproduct generates an intermediary that is electrochemically reduced on the electrode surface to generate an electrical signal that is representative of the presence of the byproduct, wherein detection of the compound of interest is determined by a decrease in the electrical signal.

Other features and advantages of the invention will become apparent from the following detailed description, taken in conjunction with the accompanying drawings that illustrate, by way of example, various features of embodiments of the invention.

### BRIEF DESCRIPTION OF THE DRAWINGS

FIG. 1 is an exemplary illustration of exemplary data from a sensor to detect exposure to agents capable of inhibiting enzymes such as, but not limited to acetylcholinesterase and cholinesterase.

FIGS. 2A-2C are exemplary illustrations of various uses of real-time data from the sensors to evaluate sensor data for exposure to inhibition agents.

FIGS. 3A-3D are exemplary illustrations of data from multiple subjects being monitored for exposure to an analyte of interest.

FIG. 4 is an exemplary illustration of various data available from multiple subjects being monitored for exposure to multiple analytes of interest, in accordance with embodiments of the present invention.

FIGS. 5A, 5B, 5C-1 and 5C-2 are exemplary illustrations depicting how data related to exposure of an analyte of interest can be utilized to assist in determining the efficacy of treatment or therapy.

FIG. 6A is an exemplary illustration of a variety of thresholds and associated operating conditions for a real-time monitoring system.

FIG. 6B is an illustration of exemplary thresholds to guide medical treatment after exposure to an analyte of interest, in accordance with embodiments of the present invention.

FIGS. 7A-7C are exemplary illustrations of working electrode configurations to enable an electrochemical implantable sensor to detect concentrations of an analyte of interest.

FIGS. 8A and 8B are embodiments of an electrode that utilize alternative techniques to create physical resistance to flux within the first transport material.

FIGS. 9A and 9B are exemplary pseudo-isometric views of sensor assemblies having multiple electrodes.

FIG. 10 is an exemplary block diagram illustrating components with a system to detect exposure to organophosphates.

### DETAILED DESCRIPTION

Acetylcholine is an organic chemical that functions as a neurotransmitter in the brain and body of many types of animals. For example, acetylcholine is the neurotransmitter that motor neurons within the nervous system release in order to activate muscles. Acetylcholine also functions as a neurotransmitter in the autonomic nervous system, both as an internal transmitter for the sympathetic nervous system and as the final product released by the parasympathetic nervous system. Within the brain, acetylcholine can function as a neurotransmitter and as a neuromodulator.

The enzyme acetylcholinesterase converts acetylcholine into choline and acetate. The role of acetylcholinesterase is to rapidly clear free acetylcholine from a synapse thereby enabling proper function. If acetylcholine within motor neurons is not timely or effectively cleared from a synapse, muscles may be overstimulated resulting in convulsions or paralysis.

As acetylcholine regulates muscle activation, but also because of its function within the brain and autonomic nervous system, many drugs and toxins exert their effects by altering cholinergic transmission. For example, varieties of plants, animals and bacteria have developed venoms and toxins that cause harm by inactivating or hyperactivating muscles through their influence on acetylcholine and its associated enzymes such as acetylcholinesterase and choline oxidase.

Inhibition of enzymes, such as, but not limited to acetylcholinesterase can result in accumulation of excess acetylcholine that, in high enough doses or quantities, can cause continuous stimulation of muscles, glands, or the central nervous system resulting in fatal convulsions. For example, some neurotoxins that inhibit acetylcholinesterase lead to an excess of acetylcholine causing paralysis of muscles required for breathing and stopping the beating of the heart. Exemplary enzyme inhibitors affecting clearance of acetylcholine include organophosphate pesticides and nerve agents such as Sarin and VX nerve gas.

Discrete measurements of analytes associated with cholinergic transmission may be useful in determining a level of exposure to inhibition agents such as organophosphates or nerve agents that affect acetylcholinesterase and subsequent clearance of acetylcholine. However, real-time monitoring may enable timely and rapid detection of exposure to inhibition agents like organophosphate based pesticides or the presence of nerve agents. Real-time monitoring can enable detection before exposure to the agent reaches levels that manifest in physical symptoms that are the common trigger for taking a discrete measurement. Accordingly, it is desirable to enable real-time monitoring to determine when changes in an environment are indicative of exposure to inhibition agents

The various embodiments discussed below should not be viewed as discrete embodiments. Rather, it is intended that various elements or components or features of the various embodiments are intended to be combined with elements, features or components of the other embodiments. While embodiments and examples may be related to particular figures the scope of the disclosure and claims should not be construed to be limited to the explicit embodiments discussed. Rather it should be recognized that various combinations of features, elements and components can be interchanged, combined and even subtracted to enable additional embodiments capable of real time monitoring for exposure to a compound of interest such as a cholinergic agent.

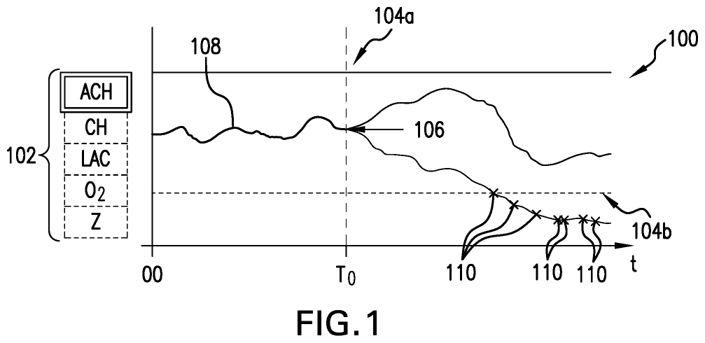

FIG. 1 is an exemplary illustration of exemplary data 100 from a sensor to detect exposure to agents capable of inhibiting enzymes such as, but not limited to acetylcholinesterase and choline oxidase, in accordance with various embodiments of the present invention. The exemplary data 100 includes a user interface 102 that enables a single or various combinations of data streams to be displayed. For simplicity, a data trace 108 is included with exemplary data 100. The data trace (alternatively, a data stream) 108 illustrated in FIG. 1 is intended to illustrate real-time measurements of acetylcholine acquired by a sensor placed within a subject over time. Some embodiments of the sensor are configured to measure a single analyte such as acetylcholine. However, in other exemplary embodiments, the sensor is configured to measure two or more analytes such as, but not limited to various combinations of analytes including acetylcholine, choline, lactate, blood oxygen, glucose, ketones, and the like.

In FIG. 1, the data 100 further includes thresholds 104a and 104b. Exemplary thresholds 104a and 104b in FIG. 1 are intended to be illustrative of relative threshold values associated with a single analyte. In embodiments where a plurality of analytes are being displayed, a corresponding plurality of threshold values could also be displayed. For example, in a non-limiting embodiment where acetylcholine and choline are being monitored in real-time, threshold values for acetylcholine can be displayed as well as threshold values for choline. In many embodiments, the user interface 102 may be used to enable or disable display of real-time data for an analyte or compound being monitored along with any threshold or thresholds associated with the respective analyte or compound.

Additionally, while threshold 104a may be viewed as an “upper” threshold, and threshold 104b may be viewed as a “lower” threshold, some embodiments may have a single threshold. For example, in some embodiments one or more analytes may include only an upper threshold 104a. Alternatively, in other embodiments, one or more compounds may include only a lower threshold 104b. The use of a single threshold can be selectively implemented based on the analyte or compound being monitored in real-time. An exemplary non-limiting example is the use of a single lower threshold when performing real-time monitoring of blood oxygen levels. As there may be no concern regarding an upper threshold, it may be desirable to have a single lower threshold for real-time monitoring of blood oxygen levels. The example provided above should not be construed as limiting and that single upper or lower threshold values can be implemented for a variety of purposes for various different analytes or compounds being monitored in real-time.

In still further embodiments, a single analyte may include multiple “upper” or “lower” thresholds. In these embodiments, the different upper or lower threshold values may be associated with various alarm levels. For example, a first alarm state can be triggered when real-time data crosses an first upper or lower threshold value. Similarly, a second alarm state can be triggered when real-time data crosses a second upper or lower threshold value.

FIG. 1 also includes TO on the x-axis that coincides with data point 106 on the data trace 108. The inclusion of TO enables detection of exposure to agents, analytes or compounds that impact cholinergic transmission by assessing relative changes in analyte over time. In many embodiments a real-time sensor configured to measure physiologically-relevant concentrations of acetylcholine is applied to a first subject under conditions where it is known that the first subject has not been exposed to agents that affect cholinergic transmission. In some embodiments the sensor is allowed to run in and acquire real-time data related to acetylcholine. TO, as contemplated in FIG. 1 is a point in time after the sensor has run-in and has established a relative baseline measurement of acetylcholine for the first subject. Subsequent real-time measurements of acetylcholine from the first subject can fluctuate within a range established by thresholds 104a and 104b that are indicative of exposure to inhibition agents that impact cholinergic transmission.

In some embodiments the thresholds 104a and 104b may be based on an increase in measured acetylcholine. For example, threshold 104a can be a value that is set as being greater than the measurement at T0. An exemplary, non-limiting illustration of such an embodiment would be measuring an acetylcholine concentration at T0 and enabling an alarm based on a threshold 104a for exposure to inhibition agents if at any time after T0, the measured concentration of in-vivo acetylcholine is measured at a level that exceeds the threshold 104a.

The embodiment discussed above is intended to be exemplary and other embodiments can use threshold values that are lower or less than the measurement at T0. This exemplary embodiment is illustrated in FIG. 1 where data points 110 are indicated being at or below threshold 104b. Still other embodiments can use multiple threshold values where a first threshold value is greater than the value at T0 while a second threshold value is less than the value at T0, Additional data points 110 are included on data trace 108

Data similar to that in FIG. 1 can also be used to directly detect exposure to agents that impact cholinergic transmission. In these embodiments, rather than using threshold values that are determined relative to a baseline value established at T0, direct detection of exposure can be based on absolute threshold values. In these embodiments exceeding a set threshold value can trigger an alarm indicating that a subject may have been exposed to an inhibition agent.

In embodiments using direct detection, multiple threshold values may be used to create escalating alarms that are indicative of likelihood of exposure. For example, alarms can escalate in visual or audible urgency as various thresholds are exceeded. In many embodiments, the alarms are provided to the subject wearing the sensor. In still other embodiments, the alarms are provided to the subject along with a centralized location monitoring multiple subjects each having a sensor to detect exposure to inhibition agents. The embodiments discussed above should not be construed as discrete embodiments. Rather, features of each of the embodiments discussed above should be considered combinable with the other embodiments discussed throughout this disclosure.

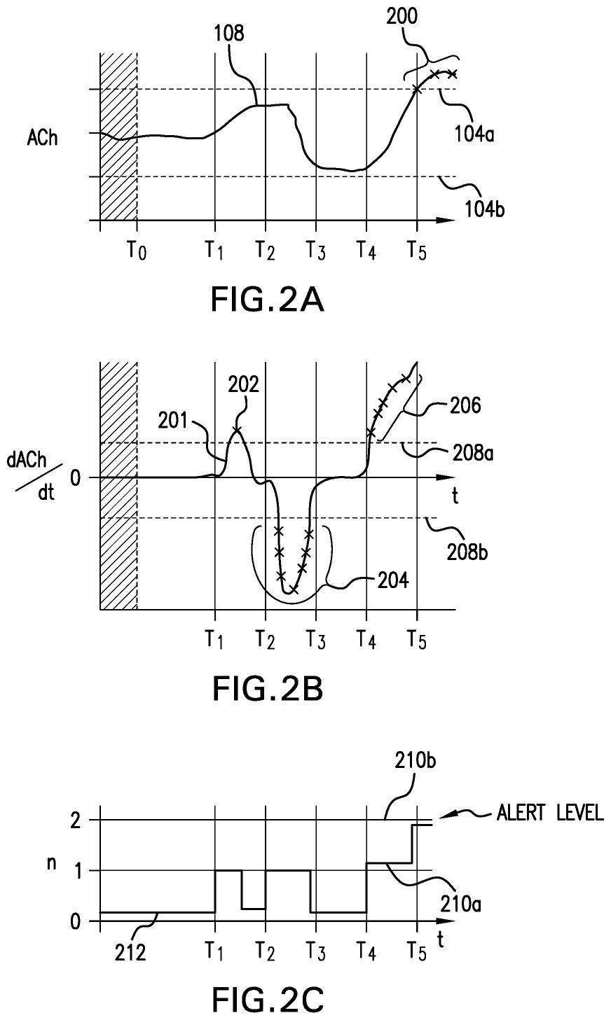

FIGS. 2A-2C are exemplary illustrations of various uses of real-time data from the sensors to evaluate sensor data for exposure to inhibition agents, in accordance with embodiments of the present invention. FIG. 2A is an exemplary illustration of real-time sensor data 108 for a subject. The exemplary data in FIG. 2A is intended to represent changes in analyte concentration over time for an analyte of interest, such as, but not limited to acetylcholine. FIG. 2B is an exemplary illustration of data 201 associated with the rate of change of the analyte of interest based on the real-time sensor data 108 in FIG. 2A. FIG. 2C is an exemplary illustration of alarm thresholds based on data from both FIGS. 2A and 2B.

Across FIGS. 2A-2C times stamps T0, T1, T2, T3, T4, and T5 are shared points in time. As discussed above, in some embodiments T0 is associated with the time after the sensor has run in and is capable of measuring relative changes in concentrations of the analyte being monitored. FIG. 2A includes thresholds 104a and 104b that may be set to enable indirect or direct exposure to chemical agents. An example of indirect detection is setting thresholds 104a and 104b relative to the sensor data 108 at T0. An example of direct detection is setting thresholds 104a and 104b at absolute values associated with generally accepted physiological parameters associated with the analyte of interest.

In FIG. 2B, data 201 is determined based on the rate of change of sensor data 108 from FIG. 2A. Additionally, FIG. 2B includes at least one threshold 208a that can be used to trigger an alarm when the rate of change of the analyte of interest exceeds the threshold value. FIG. 2B also includes threshold 208b. Similar to threshold 208a, threshold 208b can be used to trigger an alarm or alert when the rate of change of the analyte of interest exceeds the threshold value. It should be understood that the inclusion of thresholds 208a and 208 is intended to be exemplary rather than limiting. For example, various embodiments may include fewer or more threshold values associated with the rate of change of concentration of the analyte of interest.

Viewing FIGS. 2A and 2B together, at T0 data 108 remains substantially constant resulting in data 201 being substantially close to zero. At T1, data 108 begins increasing and accordingly, data 201 begins trending in a positive direction. Between T1 and T2 data 108 increases and plateaus resulting in data 201 peaking above threshold 208a at data point 202 before returning to zero. At T2, data 108 begins decreasing and data 201 accordingly turns negative. Between T2 and T3, data 108 rapidly decreases which corresponds to a large negative value in data 201, collectively illustrated as data points 204 in FIG. 2B. Note that between T2 and T3, data 201 exceeds a threshold value 208b. Between T3 and T4, data 108 in FIG. 2A is relatively steady and corresponding data 201 in FIG. 2B, being the rate of change of data in FIG. 2A, is substantially zero. Between T4 and T, data 108 in FIG. 2A increases resulting in data 201 in FIG. 2B becoming positive and exceeding exemplary threshold 208a, as illustrated collectively by data points 206. Beyond T5, data 108 in FIG. 2A exceeds threshold 104a. illustrated collectively as data points 200.

In embodiments utilizing sensor data similar to FIGS. 2A-2C, multiple threshold values associated with a single or multiple in-vivo measured analyte(s) of interest are used to further define additional threshold values 210a and 210b, in accordance with various embodiments of the present invention. FIG. 2C is an exemplary illustration of data trace 212 that is an illustration of a summation of threshold values exceeded in previously discussed FIGS. 2A and 2B. FIG. 2C includes threshold 210a which is associated with a single threshold value in FIGS. 2A and 2B being exceeded. Similarly, FIG. 2C further includes threshold 210b which is associated with two threshold values in FIGS. 2A and 2B being exceeded.

As illustrated in exemplary FIG. 2C, between T0 and T1, no threshold values in FIGS. 2A and 2B are being exceeded and data trace 212 is indicated as being zero. Between T1 and T2, threshold 208a in FIG. 2B is exceeded and accordingly, the data trace 212 being indicated as one on the y-axis of FIG. 2C. Between T2 and T3, threshold 208b is exceeded again leading to data trace 212 being one. Between T3 and T4, no threshold values are exceeded in FIGS. 2A and 2B and data trace 212 in FIG. 2C is zero. Between T4 and T5, data points 206 in FIG. 2B exceed threshold 208a resulting in data trace 212 of FIG. 2C being one. Finally, after T5, data points 200 in FIG. 2A exceeds threshold 104a in FIG. 2A, data points 206 continue to exceed threshold 208a in FIG. 2B which corresponds to data trace 212 in FIG. 2C being two. In the exemplary embodiment in FIG. 2C threshold 210b is set to two and threshold 210b can be associated with an alarm condition once the threshold 210b is reached.

The alarm condition associated with threshold 210b illustrated in FIG. 2C ensures that an alarm is raised when thresholds associated with both (a) the absolute value of the analyte of interest (FIG. 2A) and (b) the rate of change of the analyte of interest (FIG. 2B) are exceeded. The threshold values along with the number of thresholds in FIGS. 2A-2C should be considered exemplary rather than limiting. In different embodiments the number of thresholds associated with any number of the analytes of interest being monitored may vary from a single to multiple thresholds. Likewise, the number of alarm conditions associated with the various thresholds should be construed as exemplary rather than limiting. Using multiple threshold values for analytes of interest associated with embodiments illustrated in FIG. 2A, FIG. 2B, combinations of FIGS. 2A and 2B, or even additional data streams not contemplated in FIGS. 2A and 2B, can further enable alarm conditions to be refined to ensure an alarm condition is meaningful and minimize excessive alarms that can enable alarm fatigue.

Though FIGS. 2A-2C are discussed in combination above, in other embodiments it may be preferable to use a single source of data to initiate alarm conditions. For example, in some embodiments it may be preferable to use the real-time sensor data and associated thresholds from FIG. 2A to establish alarm conditions. In other embodiments, alarm conditions may be determined based on threshold associated with the rate of change data from FIG. 2B. The examples provided are intended to be exemplary rather than limiting. Additionally, the embodiments discussed above should be considered to be combinable with other embodiments discussed throughout this document.

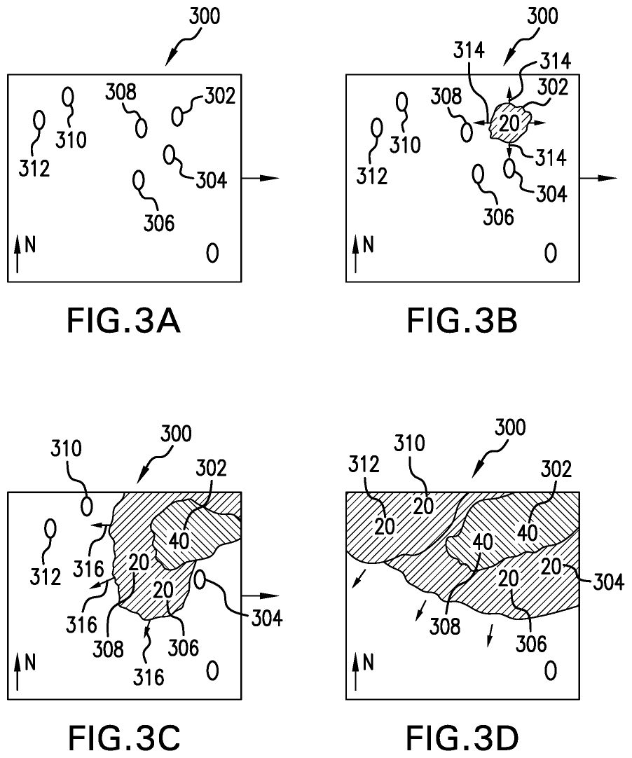

FIGS. 3A-3D are exemplary illustrations of data from multiple subjects being monitored for exposure to an analyte of interest, in accordance with embodiments of the present invention. FIGS. 3A-3D are intended to illustrate how use of location data (e.g., GPS, GLOSNASS, etc.) for individuals is combined with individual analyte sensor data for exposure to an analyte or compound of interest to enable an integrated network to determine relative direction and concentration of exposure to the compound of interest. In FIGS. 3A-3D, area 300 contains subjects 302, 304, 306, 308, 310 and 312 which are illustrated in relative position to each other. In FIG. 3A, the subjects 302-312 are illustrated in a condition where in-vivo analyte sensors have not detected an analyte of interest. In FIG. 3B, subject 302 is highlighted with a first hatched pattern along with the numeral 20 indicating that the in-vivo sensor associated with subject 302 has detected that subject 302 has been exposed to the analyte of interest. The use of both the first hatched pattern and the numeral 20 is intended to convey an initial exposure state. In many other embodiments, the numeral 20 along with the first hatched pattern could be replaced by a first color having a first opacity associated with the color.

Additionally, in other embodiments, color characteristics such as, but not limited to opacity, saturation, hue, and brightness can be associated with concentration of analyte being detected. Accordingly, while the numeral 20 and hatching are used to indicate a specific state at a specific point in time, the real-time nature of the measurements from the sensors can enable significantly more nuanced display such as, but not limited to color gradients, color brightness and the like that may be associated with sensor data such as rate of change. Throughout the remainder of this disclosure, the use of numerals and various hatch patterns is intended to convey different combinations of color and variations of color associated with exposure of a subject to an analyte of interest.

For simplicity, in FIG. 3C subject 302 is represented by the numeral 40 along with a second hatching pattern. The numeral 40 and second hatching pattern are intended to indicate that the sensor associated with subject 302 is detecting a higher level of the analyte of interest than the numeral 20. In many embodiments the numeral 40 and hatching pattern would be replaced by a second color, thereby quickly and clearly conveying the increased exposure to subject 302 to individuals or entities monitoring the area 300. In FIG. 3C subjects 306 and 308 are indicated with numeral 20 and the first hatched pattern. This is intended to indicate that sensors associated with both subjects 306 and 308 have detected exposure to the analyte of interest. In some embodiments, arrows 314 are used to indicate an estimated direction of travel of the analyte of interest. Arrows 314 should be construed as exemplary as other embodiments can use alternative graphics cues such as a graphic pulsation of an estimated boundary front of the analyte of interest.

In FIG. 3D, subjects 306, 304, 310 and 312 are indicated as numeral 20 while subjects 302 and 308 are indicated as numeral 40. In some embodiments, upon initial detection of the analyte of interest in a first subject, the sampling rate of sensors associated with every subject in the group being monitored may be adjusted. Alternatively, because the relative position of each subject is known, there is a change in the sampling rate of only the subjects closest to the first subject that detected the analyte of interest. For example, in FIG. 3B, when subject 308 first indicated exposure to the analyte of interest, the sampling rates for sensors associated with every subject may be increased. In other embodiments, the sampling rates for sensors associated with subjects 304, 306 and 308 are increased. In many embodiments, changes in the sampling rate for sensors is performed automatically. In other embodiments, changes in the sampling rate for individual subjects may be performed remotely either manually or semi-automatically; where an example of semi-automatic change is manually confirming an automatically generated request to change the sampling rate of an individual sensor or groups of sensors.

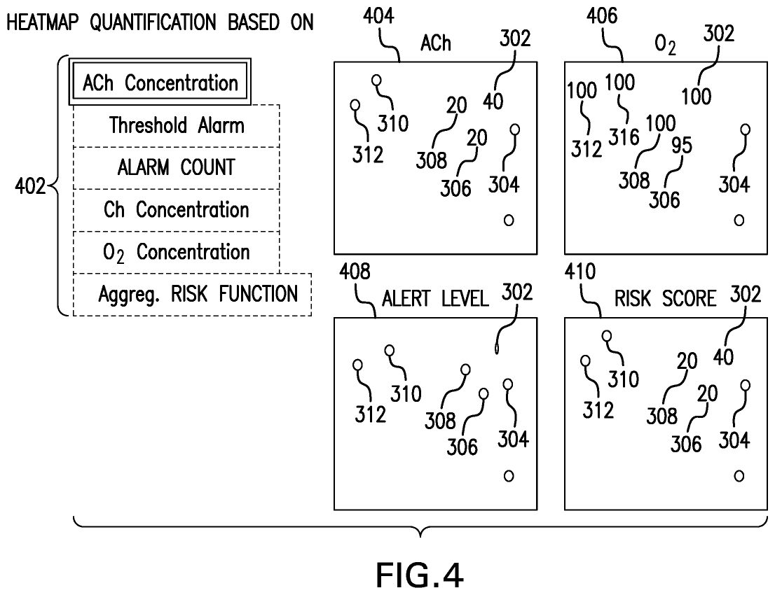

FIG. 4 is an exemplary illustration of various data available from multiple subjects being monitored for exposure to multiple analytes of interest, in accordance with embodiments of the present invention. FIG. 4 is intended to illustrate various combinations of data that can be displayed based on the conditions illustrated in FIG. 3C. Graphical user interface (GUI) 402 is an exemplary illustration of data that can be acquired along with alarm or alert thresholds associated with the data from individual multianalyte sensors associated with the users 302, 304, 306, 310 and 312. GUI 402 is intended to be illustrative of an embodiment for use measuring analytes associated with detection of inhibition. Accordingly, GUI 402 includes, but is not limited to display acetylcholine concentration, choline concentration, and blood oxygen concentration. Additionally, exemplary GUI 402 can display threshold alarms, alarm counts, and risk functions based on the sensor data from the users.

Display 404 is intended to be illustrative of measurements of acetylcholine in subjects 302-12. Subject 302 is indicated by the numeral 40 that is intended to convey that the exposure of subject 302 is greater than the exposure of subjects 306 and 308 that are represented by the numeral 20. Display 406 is intended to be an exemplary illustration of blood O2 concentration of the subjects 302-312 with the various subjects being represented by the numerals between 95 and 100.

Display 408 is an exemplary representation of alert levels associated with the subjects 302-12. In many embodiments the alert levels in display 408 are based on real-time data shown in display 404 and display 406. In other embodiments, the alert levels in display 408 are based on a single or multiple data streams from the individual sensors associated with the subjects, including additional data streams not illustrated in FIG. 4. Because subject 302 has the highest acetylcholine concentration, subject 302 is indicated by the numeral one. Additional subjects 304-312 are indicated as being numeral zero. In many embodiments the numeral 0 may be more accurately represented by the color green, indicating that subjects 304-312 are not approaching an alert or alarm level. Similarly, the numeral one in display 408 may be represented by the color yellow, indicating that subject 302 may be trending toward an alert or alarm level.

Display 410 is an exemplary illustration of a risk score of the subjects being exposed to the analyte of interest. Accordingly, in this exemplary embodiment, display 410 is an illustration of a risk score of the subjects being exposed to an inhibition agent. In many embodiments the risk score in display 410 is based on the data found in display 404, 406 and 408. In other embodiments the risk score is based on one or more of the data streams in display 404, 406 and 408. In some embodiments, the risk score may be based on data streams acquired by the real-time sensors associated with the subjects, but not necessarily shown in displays 404-408. Examples of data that may not be found in display 404-408 includes, but are not limited to rates of change, interpolation of data and the like. In many embodiments the risk score is a weighted moving average based on one or more data streams.

FIGS. 5A, 5B, 5C-1 and 5C-2 are exemplary illustrations depicting how data related to exposure of an analyte of interest can be utilized to assist in determining the efficacy of treatment or therapy, in accordance with embodiments of the present invention. In addition to providing insight when a subject has been exposed to an analyte of interest, the real time sensor system can additionally provide insight regarding treatment or the efficacy of therapy after exposure to the analyte of interest. The following discussion is directed toward an embodiment where the sensor system is configured to detect or measure exposure to inhibition agents. However, it should be understood that such an embodiment should be construed as exemplary and other embodiments can be used to detect and measure exposure to various other analytes such as, but not limited to those that are utilized in a similar manner as choline, acetylcholine and the like.

Inhibition agents can create an excessive amount of acetylcholine by either affecting the ability of acetylcholinesterase to clear acetylcholine, or the inhibition agents can increase the persistence of acetylcholine. One advantage of obtaining real-time data regarding the concentration of acetylcholine is being able to determine the rate of change. Accordingly, real-time sensor data can quantitatively illustrate the efficacy of neutralizing the effects of any inhibition agent or agents. In some instances, treatment that was thought to be sufficient can be quantitatively determined to be insufficient if the concentration of acetylcholine increases, or the rate of change of the concentration of acetylcholine is determined to be less than optimal. Similarly, treatment for exposure to inhibition agents may be determined to be over aggressive if acetylcholine concentrations drop too quickly or below a threshold value.

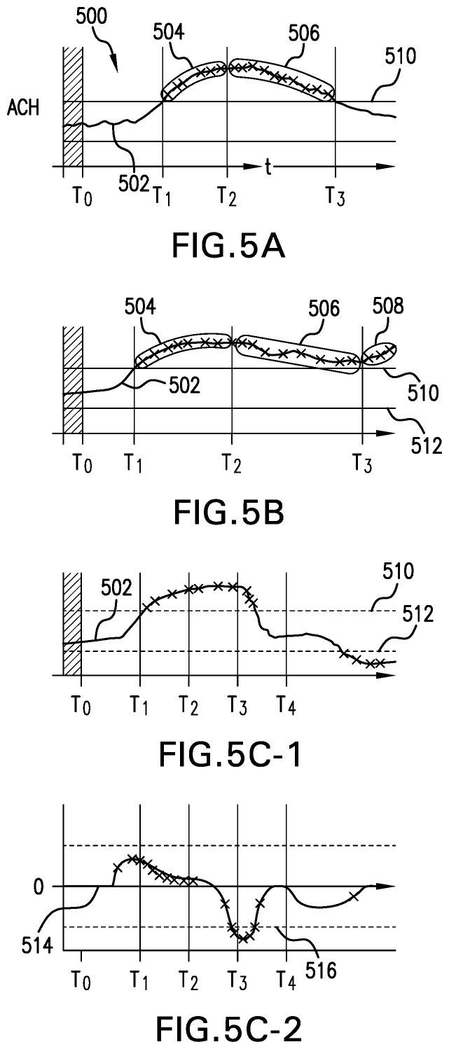

In FIG. 5A, the data trace 502 indicates that the concentration of acetylcholine exceeds threshold 510 at T1, therapy is initiated at T2, and T3 is a point in time where the data trace 502 goes below the threshold 510. Additionally, data points 504 are found between T1 and T2, while data points 506 are found between T2 and T3. In some embodiments, a first alarm condition is enabled at T1 when the acetylcholine level first reaches threshold 510. Upon initiation of treatment/therapy at T2, in many embodiments the first alarm state is cancelled.

In many embodiments at T2, the system can be placed in a warning mode. In some embodiments, the warning mode may be associated with a sample rate that is higher or lower than prior to T2. The warning mode may also optionally include setting another threshold value that is higher than threshold 510. The another threshold value associated with T2 can be set to a fixed percentage of the acetylcholine concentration at T2 in order to provide caretakers insight that the initiation of treatment has not had the desired effect of bringing down acetylcholine concentrations with the subject.

As illustrated in FIG. 5A, after T2 the acetylcholine concentration of the subject begins decreasing, as shown in data points 506. At T3, data trace 502 reaches the threshold 510. Accordingly, at T3 the system can automatically exit warning mode and resume monitoring the subject at a frequency similar to that at T0.

FIG. 5B is similar to FIG. 5A but at T3, rather than reaching the threshold 510, data trace 502 includes an inflection point where the concentration of acetylcholine begins to increase. The change of inflection of the data trace 502 can be indicative of ineffective or insufficient treatment for the subject. The embodiments illustrated in FIGS. 5A-5C are exemplary and should not be construed as limiting. It should be understood that embodiments discussed in FIGS. 5A-5C may be combined with the various other embodiments discussed throughout this document. For example, FIGS. 5A-5C are based on measurements of a single analyte, acetylcholine, while real-time monitoring of multiple analytes of interest was discussed above. Accordingly, in some embodiments data streams from multiple analytes of interest may be used to determine efficacy of therapy or treatment. Similarly, rate of change data for data streams related to a single or a plurality of analytes may also be used to determine efficacy of treatment. Furthermore, while FIGS. SA-5C were discussed with regards to detecting exposure to an inhibition agent, other embodiments may detect exposure to a variety of other analytes capable of impacting other biological functions.

In FIG. 5C-1, exemplary data 502 is based on real-time measurements of acetylcholine over time for a subject. FIG. 5C-2 further includes exemplary data 514 that shows rate of change based on data 502 in FIG. 5C-1. As with other embodiments, acquisition of sensor data 502 and rate of change data 514 begins at T0. Between T0 and T1, sensor data 502 begins increasing and the increase is reflected in the corresponding rate of change data 514. At T1 sensor data 502 reaches and subsequently exceeds threshold 510. At T2, treatment of the subject begins bringing the rate of change data closer to zero. At T3, the sensor data 502 begins decreasing and the corresponding rate of change data 514 exceeds a lower threshold 516. The rapid decrease captured by the real-time sensor may be indicative of excessive or overtreatment of the subject. Having an alarm associated with lower threshold 516 can enable modification of the treatment to improve the outcome for the subject.

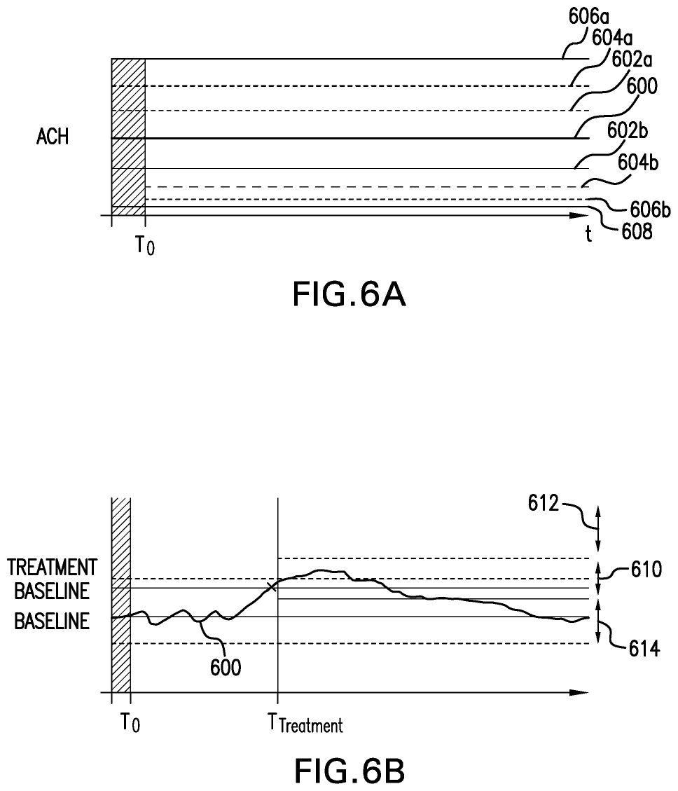

FIG. 6A is an exemplary illustration of a variety of threshold and associated operating conditions for a real-time monitoring system, in accordance with embodiments of the present invention. For simplicity, FIG. 6A includes thresholds and operating conditions for a system based on the measurement of a single analyte of interest. In this embodiment, the analyte of interest is acetylcholine. As previously discussed, in many embodiments a baseline 600 concentration of acetylcholine is established at T0. In some embodiments, baseline 600 enables all subsequent threshold values to be set relative to the baseline 600. FIG. 6A includes a warning thresholds 602a and 602b, where 602a is an upper threshold and 602b is a lower threshold. Additional exemplary thresholds include alert threshold 604a and 604b, where 604a is an upper threshold and 604b is a lower threshold. Critical thresholds 606a and 606b are also included, where 606a is an upper threshold and 606b is a lower threshold.

Additionally, in some embodiments an additional lowest threshold 608 is included that can indicate that the sensor is no longer functioning or automatically begin a sensor initialization procedure. Alternatively, in other embodiments when the data 600 exceeds the lowest threshold 608, the system may advise the user or system administrator that the sensor may need to be changed.

In various embodiments data traces or data points may be displayed in a color such as green when measurements from the sensor are between the alert thresholds 604a and 604b. When the sensor data exceeds either of the alert thresholds 604a and 604b data traces or data points may be displayed in a different color such as yellow or orange. When the sensor data exceeds either of the critical thresholds 606a and 606b data traces or data points may be displayed in a different color such as red.

In some embodiments threshold values for sensor data may be set automatically or manually reprogrammed while the sensor is detecting concentrations of the analyte of interest. For example, when a sensor is first applied to a subject a first threshold value is applied to warn the subject of possible exposure to the analyte of interest. A second threshold value can subsequently be either manually or automatically applied to provide additional warning to the user to seek medical attention. In embodiments where the sensor continues to acquire data as a subject seeks treatment for exposure to the analyte of interest, a subsequent threshold value can be either manually or automatically applied to warn either the subject or medical personnel regarding the efficacy of the treatment. The thresholds discussed above are intended to be exemplary and while changes to display color for the data or data points is explicitly discussed, other combinations of audible, tactile, and visual cues may be used when data crosses any of the exemplary thresholds.

FIG. 6B is an illustration of exemplary thresholds to guide medical treatment after exposure to an analyte of interest, in accordance with embodiments of the present invention. Data trace 600 is included for illustrative purposes and begins at T0. At T0 the data 600 exceeds a critical threshold and treatment is initiated. Upon initiation of treatment, a single or multiple threshold values can be manually, semi-automatically, or automatically established to guide or assist in determining efficacy of the treatment. In FIG. 6B, three exemplary thresholds ranges are illustrated. For example, threshold range 610 is a “continue treatment range”, while threshold range 612 is an “increase treatment range”, and range 614 is a “stop treatment range”. Each respective range in FIG. 6B may be defined relative to the baseline or simply be an absolute value change from what was measured at T0.

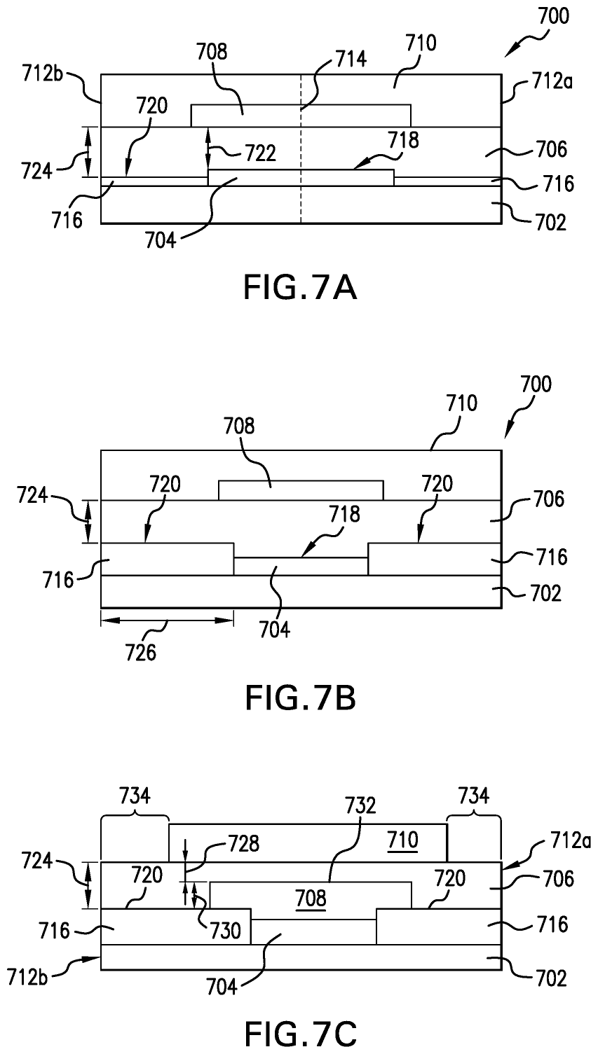

FIGS. 7A-7C are exemplary illustrations of working electrode configurations to enable an electrochemical implantable sensor to detect concentrations of an analyte of interest, in accordance with embodiments of the present invention. Broadly, the sensor includes at least one or more immobilized enzymes within a three-dimensional matrix that allows excess enzyme loading. The three-dimensional matrix also enables boundaries that are engineered to provide mass transfer limited access of the compound or analyte being detected to the immobilized enzyme through a single or multiple transport conduits. In some embodiments the transport conduit (or conduits) consist of crosslinked areas or regions of hydrophobic and hydrophilic materials selectively designed and positioned via geometry and material properties to significantly restrict flow of the compound or analyte being detected (or measured) and enzyme substrate.

In embodiments where the compound, material, or analyte being detected is an inhibition agent such as, but not limited to an organophosphate, detection of the presence of the compound is accomplished through the inhibition of acetylcholinesterase or choline oxidase. In embodiments detecting inhibition of acetylcholinesterase, changes in concentration of acetylcholine can be detected with acetylcholinesterase being used as at least one enzyme within the sensor. In embodiments detecting inhibition of acetylcholinesterase via changes in choline, changes in concentration of choline, and by reference, acetylcholine and acetylcholinesterase, can be detected using choline oxidase as at least one enzyme within the sensor.

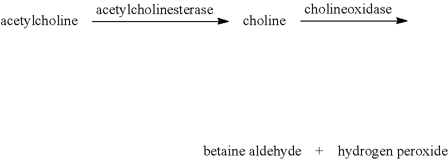

As illustrated in the simplified chemical reaction above, Inhibition of acetylcholinesterase results in the inhibition of choline available to react with choline oxidase that in turn results in a reduction in hydrogen peroxide. The application of an applied potential to the electrode positioned near the enzyme is capable of measuring the current generated by the decomposition of the hydrogen peroxide. Accordingly, in many embodiments, inclusion of excessive immobilized choline oxidase enzyme combined with sufficient run in time for the sensor establishes the baseline described above, enables a decrease in current to signify that choline generation is being inhibited vis-a-vis inhibition of acetylcholinesterase.

An alternate perspective is that acetylcholine is the compound of interest and choline, a byproduct of the compound of interest, interacts with choline oxidase to produce an electrical signal proportional to the changes in either the compound of interest or the byproduct of the compound of interest. In many embodiments, a decrease in measured current from the decomposition of hydrogen peroxide generated by the reaction between the byproduct and the reactive chemistry is associated with detection of inhibition of clearance of the compound of interest.

FIG. 7A is an exemplary illustration of a cross-section of a working electrode 700 configured to measure an analyte of interest, in accordance with embodiments of the present invention. In many embodiments the working electrode 700 includes a substrate 702, an electrode 704, a first transport material 706, a reactive chemistry 708, and a second transport material 710. The substrate 702 can be a conductive or semiconductor material that includes masking to expose an area of the substrate 702 that forms the electrode 704. Exemplary materials for the substrate 702 include, but are not limited to stainless steel, copper, or other conductive materials.

In many embodiments, masking 716 is selectively applied to the substrate 702 to selectively expose a portion or window of the substrate 702 where the electrode 704 is created. The masking 716 is commonly selected from non-conductive materials such as, but not limited to kapton or similar materials. In some embodiments, openings, windows, or apertures in the masking 716 expose the substrate 702 and the electrode 704 is simply the exposed portion of the substrate 702. In many embodiments, the electrode 704 is defined by preparing the exposed substrate 702. Example operations that can be used to prepare the exposed substrate 702 and form the electrode 704 include cleaning operations along with single or multiple electroplating operations with materials such as, but not limited to silver and platinum.

In many embodiments, a first transport material 706 is applied over the electrode 704, the masking 716 and the substrate 702. The first transport material 706 can encapsulate the electrode 704 and also extend to the edges 712a and 712b of the electrode 700. In many embodiments it is desirable for the first transport material 706 to freely enable transportation of bodily fluid from the edges 712a and 712b toward the electrode 704. Exemplary materials for the first transport material 706 include, but are not limited to hydrogel materials.

As previously discussed, a design feature of the transport conduit partially defined with the first transport material 706 is restriction of the flow or flux of compounds or analyte(s) being detected and enzyme substrate. As illustrated in FIG. 7A, a top surface 718 of the electrode 704 is illustrated as being above, or higher, than surface 720 of the masking 716. Having the top surface 718 being above surface 720 results in width 722 of the first transport material over the electrode 704 being less than the width 724 of the first transport material 706 at the edges 712b and 712a. This change in ratio between the width of the first transport material at the edge and over the electrode physically restricts flow or flux of interstitial fluid and the compounds, analytes and enzyme substrates therein.

In many embodiments, the reactive chemistry 708 is disposed over a portion of the first transport material 706. In some embodiments, the reactive chemistry 708 includes, but is not limited to an enzyme and another material that immobilizes the enzyme within a three-dimensional matrix that still enables movement or flux of compounds or analytes found within interstitial or subcutaneous fluid. Enzymes may be selected based on the analyte or compound being measured. Exemplary enzymes include glucose oxidase, lactate oxidase, acetylcholinesterase, choline oxidase and the like. Exemplary materials to immobilize the enzyme include hydrogel materials.

In some embodiments the reactive chemistry 708 is placed substantially coincident with the electrode 704 albeit separated from the electrode 704 by the first transport material 706. For example, if the electrode 704 has a circular shape, the reactive chemistry 708 is substantially the same size and aligned concentrically with the electrode 704. In other embodiments, the reactive chemistry 708 is larger than the electrode 704. For example, if the electrode 704 has a circular shape, the reactive chemistry 708 is shaped and positioned to be larger or greater than the opening for the electrode 704. As the reactive chemistry 708 is larger than the electrode 704, the reactive chemistry 708 can be viewed as being able to cast a shadow over the entirety of the electrode 704 when separated from the electrode 704 by the first transport material 706

In other embodiments, the reactive chemistry 708 is applied in a pattern over (alternatively, on top of) the electrode 704 without having the first transport material between the electrode 704 and the reactive chemistry 708. In still other embodiments, the electrode 704 is initially completely covered by the first transport material 706 and the reactive chemistry 708 is subsequently applied over the first transport material 706 and also the reactive chemistry while further being applied beyond the area defined by the electrode 704. In many embodiments where the reactive chemistry 708 is placed over or is larger than the electrode 704, the reactive chemistry 708 and the electrode share a substantially similar shape (e.g., circular, rectangular, various other polygons, etc.) along with being substantially aligned along the axis 714. In other embodiments, the reactive chemistry 708 and the electrode 704 are different shapes. For example, in some embodiments the electrode 704 may be substantially circular while the reactive chemistry 708 is a polygon. In still other embodiments, the reactive chemistry 708 and the electrode 704 are not substantially aligned along the axis 714.

In still other embodiments, the shadow cast by the reactive chemistry 708 over the electrode 704 does not fully eclipse the entirety of the electrode 704. For example, in some embodiments, the reactive chemistry 708 only partially shadows the electrode 704. The embodiments described above should be construed as exemplary and not restrictive. Furthermore, the embodiments described above should be construed as being implemented individually or in various combinations with other embodiments disclosed throughout this paper. In embodiments where the sensor is configured to detect organophosphates, the reactive chemistry 708 may include enzymes such as acetylcholinesterase or choline oxidase.

In some embodiments, a second transport material 710 is applied over the reactive chemistry 708. The second transport material 710 may be selected based on its ability to minimize or eliminate transport or flux of the analyte or compound of interest (being measured) while also enabling transport of flux of a reactant necessary for either the reaction between the analyte of interest and the enzyme or the reaction between X and Y. A non-limiting exemplary material for the second transport materials 710 is silicone. Silicone enables transport of oxygen while being substantially impermeable or impervious to glucose, lactate, choline and other analytes of interest.

Thus the second transport material 710 restricts entrance of the analyte or compound of interest to the sides 712a and 712b through the width 724 of the first transport material 706. Simultaneously, the second transport material 710 enables transport of oxygen across the entire surface of the reactive chemistry 708 to enable complete reaction when the analyte of interest reacts with the reactive chemistry 708.

FIG. 7B is an exemplary illustration of a cross-section of a working electrode 700 configured to measure an analyte of interest, in accordance with embodiments of the present invention. Similar to the embodiment illustrated in FIG. 7A, a first transport material 706 is applied over the electrode 704, the masking 716 and the substrate 702. The first transport material 706 can encapsulate the electrode 704 and also extend to the edges 712a and 712b of the electrode 700. In many embodiments it is desirable for the first transport material 706 to freely enable transportation of bodily fluid from the edges 712a and 712b toward the electrode 704. Exemplary materials for the first transport material 706 include, but are not limited to hydrogel materials.

Another similarity to the embodiments shown in FIG. 7A, is that the working electrode 700 in FIG. 7B includes an electrode 704 formed over exposed conductor 702. The conductor 702 being exposed via an opening or gap in masking 716. However, In FIG. 7B, the top surface 718 of the electrode 704 if formed below, or recessed from the surface 720 of the masking 716. Accordingly, in the embodiment illustrated in FIG. 7B, the width 714 of the first transport material 706 at the edges 712a and 712b may be substantially similar to the width of the first transport material 706 near the electrode 704. However, while not illustrated to scale, it should be appreciated that the width 724 is significantly less than length 726 that separates the edges 712b and 712a from the electrode 704. Accordingly, the ratio of width 724 to length 726 creates physical resistance for the movement of interstitial fluid and the diffusion of associated analytes or substances or compounds of interest as they move from the edges 712a and 712b toward being consumed via electrochemical reaction between the reactive chemistry 708 and the electrode 704. Adjusting the ratio of width 724 to length 726 can enable tuning of the diffusion path of the analytes or compounds of interest within interstitial or subcutaneous fluid through the implanted sensor.

FIG. 7C is another exemplary illustration of a cross-section of a working electrode 700 configured to measure an analyte or compound of interest, in accordance with embodiments of the present invention. In FIG. 7C the reactive chemistry 708 is placed directly over the electrode 704. As illustrated in FIG. 7C, the reactive chemistry 708 may also be applied over the masking 716. In alternative embodiments, the reactive chemistry 708 is located to minimize covering the masking 716. In embodiments where the reactive chemistry 708 is applied directly over the electrode 708, the reactive chemistry may be applied so surface 732 of the reactive chemistry 708 is substantially coincident with surface 720 of the masking 716. In alternative embodiments, the thickness of the reactive chemistry 708 may result in the surface 732 of the reactive chemistry 708 being below surface 720 of the masking 716. In still other embodiments, the surface 732 of the reactive chemistry 708 is as illustrated in FIG. 7C and is above surface 720 of the masking 716.

The first transport material 706 is applied over the masking 716 and the reactive chemistry 708. In exemplary embodiments, the first transport material 706 extends to the edges 712a and 712b and is applied having a thickness 728 over surface 732 of the reactive chemistry 708. In preferred embodiments, thickness 728 is less than width 724 of the first transport material 706 at the edges 712a and 712b. The difference between thickness 728 and width 724 creates physical resistance for analytes and compounds within the first transport material 706. The change in cross-sectional area created by the difference between thickness 728 and width 724 and commensurate physical resistance associated therewith enables mass transfer limitations for analytes or compounds moving within the first transport material 706.

In many embodiments, performance of the sensor is tuned by varying the ratio between thickness 728 and width 724. Additionally, FIG. 7C includes an alternative embodiment of the application of the second transport material 710. In both FIGS. 7A and 7B the second transport material 710 is applied to coincide with the edges 712a and 712b. However, in FIG. 7C, the second transport material 710 is intentionally applied to not coincide with the edges 712a and 712b. Stated another way, the second transport material 710 is recessed from the edges 712a and 712b. Accordingly, rather than limiting access to the first transport material 706 along the edges 712a and 712, in FIG. 7C additional surface area 734 of the first transport material 702 is capable of enabling greater access of analytes or compounds to the first transport material 702 than embodiments with only access via edges 712a and 712b. Because of the increased access to the first transport material 702, many embodiments may include multiple mechanical features to physically restrict movement of materials within the first transport material 706 toward the electrode 718. It should be understood that in other embodiments, the second transport material 710 extends to the edges 712a and 712b, as illustrated in FIGS. 7A and 7B.

In many embodiments the first transport material 710 is a hydrogel material capable of enabling transport of interstitial fluid from an exterior of the sensor across and through the entirety of the hydrogel material. In preferred embodiments the first transport material 710 does not impede transport of flux of interstitial fluid and the associated analytes therein. An alternative perspective is that the first transport material 710 freely enables all analytes contained in interstitial fluid, such as, but not limited to glucose and oxygen, to move unimpeded throughout the first transport material.

As discussed above, dimensional properties of the first transport material 710 can be used to tune performance of the first transport material. Alternatively, or in addition to tuning a sensor using dimensional changes, in some embodiments the first transport material 710 is comprised of a plurality of materials having similar yet distinguishable properties. For example, in some embodiments the first transport material includes a first hydrogel and a second hydrogel. In these embodiments both the first and second hydrogels freely enable transport or flux of interstitial fluid and associated analytes. However, various properties associated with the first and second hydrogel can enable tuning of sensor properties. In some embodiments there is a difference in transport rate between the first hydrogel and the second hydrogel. In other embodiments, a second hydrogel is used to encapsulate or surround the reactive chemistry. In the various embodiments, a first transport material made of multiple hydrogels should be construed as feely enabling transport or flux of interstitial fluid and all the analytes contained therein.

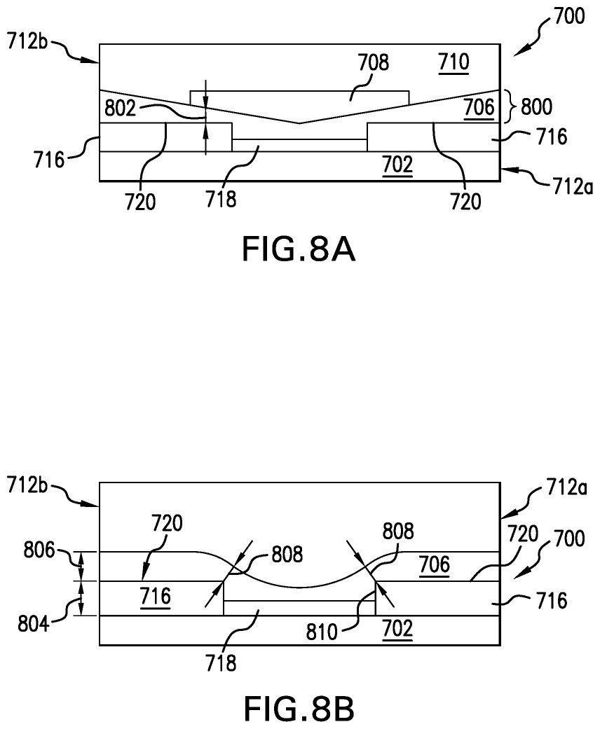

FIGS. 8A and 8B are embodiments of an electrode 800 that utilize alternative techniques to create physical resistance to flux within the first transport material 706, in accordance with embodiments of the present invention. FIG. 8A is an exemplary illustration of an electrode 700 where the first transport material 706 is intentionally geometrically formed or shaped to restrict or constrict movement of analytes or compounds from the edges 712a and 712b toward the electrode 718. In FIG. 8A the electrode 718 is formed below the surface 720 of the masking 716 and the first transport material 706 is located over both the electrode 718 and the masking 716. In FIG. 8A, at the edges 712a and 712b, the first transport material 706 is formed at a first thickness 800. However, closer to the electrode 718, the first transport material 706 is formed at a second thickness 802, where the second thickness 802 is less than the first thickness 800. Accordingly, the thickness of the first transport material 706 decreases from the edges 712a and 712b toward the electrode 718. As the portion of the first transport material 706 exposed at the edges 712a and 712b is responsible for introducing fluid surrounding the sensor to the electrode, the decrease in width of the first transport materials 706 is a physical or mechanical restriction on flow of fluid and associated analytes or compound to the electrode 718.

In some embodiments, the change in thickness of the first transport material is created during the process of depositing the first transport material 706. For example, in some embodiments, where the first transport material 706 is screen printed, the change in thickness of the first transport material is created mechanically during the application process, e.g., during a squeegee operation. In alternative embodiments, where the first transport material 706 is applied using a spinning deposition process, the first transport material may be applied in a substantially central location of the substrate and the change in thickness of the first transport material 706 is accomplished by the application of centripetal (rotation) motion. The embodiments described above should be considered exemplary rather than limiting. Other techniques and processes may be used to create a change in thickness of the first transport material.

FIG. 8B is an additional exemplary illustration of using mechanical properties of components or elements within the sensor 700 to tune or adjust restriction within the first transport material 706, in accordance with embodiments of the present invention. In this embodiment, the masking 716 is formed at a thickness 804 and the first transport material 706 is formed at a thickness 806. The electrode 718 is formed a distance 810 below the surface 720 of the masking 716. Accordingly, a ratio of less than one is established between the distance 810 and the thickness 804. The smaller the ratio between distance 810 and thickness 804 can result in the thickness 808 of the first transport material 706 nearer the electrode 718 than the thickness 806 of the first transport material 706 at the edges 712a and 712b. The smaller the ratio between thickness 808 and thickness 806 results in a greater decrease in internal surface area available to transport fluid from the edges 712a and 712b to the electrode 718.

Accordingly, in some embodiments sensor performance (e.g., physical restriction of flow or flux through the first transport material) is tunable by varying the ratio between the distance 810 and the thickness 804. In other embodiments, the ratio between the thickness 804 and the thickness 806 may be changed to change sensor performance. Furthermore, in still other embodiments, sensor characteristics regarding adjusting or tuning flux or flow through the first transport material may be accomplished via combinations of the various other embodiments discussed throughout this paper. For example, ratios discussed in FIG. 8B may be combined with ratios discussed in FIG. 7B. Furthermore, ratios discussed in FIG. 8B may be combined with ratios discussed in FIG. 7B and the shaping embodiments discussed in FIG. 8A. The various embodiments discussed should be considered as being combined as long as the various combinations may be combined without changing the fundamental operation of the sensor.

The electrode embodiments described in FIGS. 7A-7C and FIGS. 8A and 8B can be operated to electrochemically detect the presence of organophosphate inhibition agents through the inhibition of acetylcholine and/or choline. In embodiments intended to detect inhibition of acetylcholine the reactive chemistry would include acetylcholinesterase. In embodiments intended to detect inhibition of choline the reactive chemistry would include choline oxidase. In still further embodiments of the electrode, acetylcholinesterase and choline oxidase are used within a working electrode. In embodiments utilizing multiple enzymes, it may be beneficial to create a first reactive chemistry and a second reactive chemistry similar to those described in U.S. patent application Ser. No. 16/153,727 which is herein incorporated by reference for all purposes.

Although the organophosphate inhibitors covalently link to the esteratic subsite of the acetylcholinesterase active site, the immobilization of high concentrations of acetylcholinesterase within a suitable polymeric or protein matrix provides at minimum partial protection of the acetylcholinesterase active site from irreversible inactivation through a combination of chemical protection provided by the immobilization matrix and through steric hindrance while a kinetic excess of enzyme allows enzyme availability to the diffusion limited supply of acetylcholine to allow continuous monitoring of the vital neurotransmitter concentration in the environment surrounding the sensor even if some fraction of the immobilized enzyme is reversibly or irreversibly inhibited by an organophosphate.

The sensors and electrodes described above can be operated continuously in the presence of an inhibitor and can be used to detect the removal of the inhibitor from the environment of the effectiveness of therapeutic intervention designed to allow acetylcholinesterase present in the host implanted with the sensor to regain physiological function. The inclusion of choline oxidase provides an integrity check of overall sensor function since its enzyme activity is reversibly impacted by the presence of organophosphates. In some embodiments, the inclusion of a separate choline oxidase sensor that may be spatially separated from the acetylcholinesterase sensor whose signal can be amplified relative to the choline sensor through distance of the acetylcholinesterase layer from the boundary where acetylcholine and choline partition into the sensor, one is able to distinguish the effect of organophosphates from other inhibitors of choline oxidase. Additionally, various other configurations or embodiments of electrodes or sensors based on the principles described herein where a single sensor or electrode can detect the presence of organophosphate nerve agents or blister agents such as mustard gas, a known reversible inhibitor of choline oxidase.

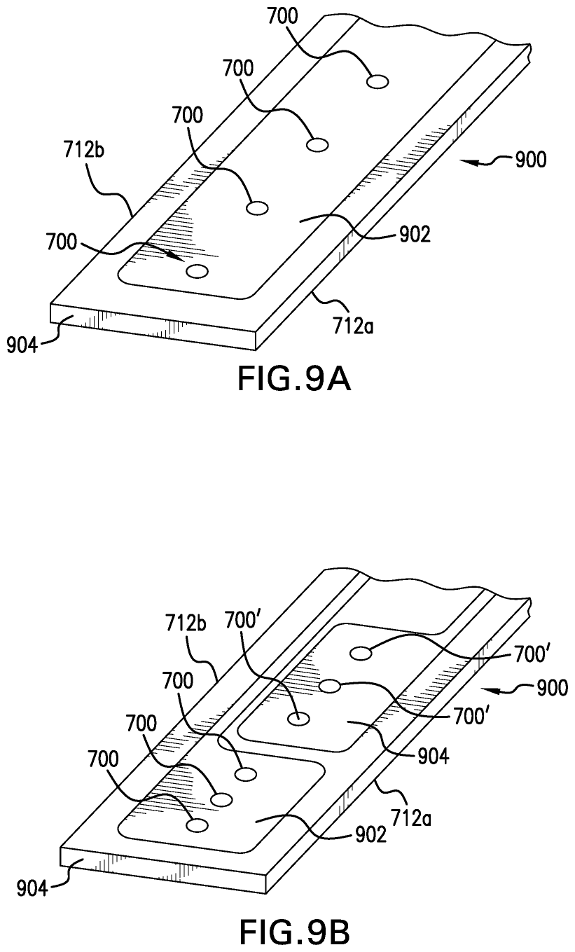

FIGS. 9A and 9B are exemplary pseudo-isometric views of sensor assemblies 900 having multiple electrodes 700, in accordance with embodiments of the present invention. The exemplary illustrations in FIGS. 9A and 9B are of a sensor assembly 900 from a distal end 904 looking toward a proximal end. FIG. 9A represents a simplified view of a sensor assembly 900 configured to measure a single analyte or compound using individual electrodes 700 formed on a first substrate 902. FIG. 9B represents a simplified view of a sensor assembly 900 configured to measure a plurality of analytes or compounds using individual electrodes 700 formed on a first substrate 902 and individual electrodes 700′ that are formed on a second substrate 904.

For simplicity the proximal end is not illustrated but it should be well understood that electrical contacts for the respective substrates 900 and 902 and associated electrodes 700 and 700′ are located at the proximal end. Also for simplicity, the individual layers such as the masking, first transport material, reactive chemistry and second transport material are not illustrated in FIGS. 9A and 9B.

It should be understood that in embodiments configured to measure more than one analyte or compound, the sensor assembly 900 includes both a first and second substrate. The first and second substrate are electrically isolated from each other and placement of the respective reactive chemistries is accomplished by masking off areas that are not intended to be exposed to the processes occurring on the unmasked portion of the sensor assembly 900.

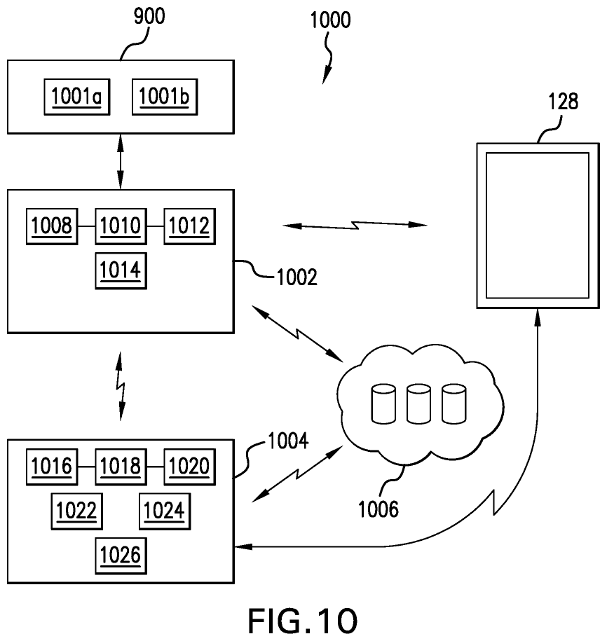

FIG. 10 is an exemplary block diagram illustrating components with a system 1000 to detect exposure to organophosphates, in accordance with embodiments of the present invention. Broadly, the system 1000 includes a sensor array 900 that includes first analyte sensors 1001a along with optional second analyte sensors 1001b that are powered by an electronics module 102 that further enables bi-directional communication with a plurality of remote devices, such as, but not limited to an external monitor 1004, cloud computing systems 1006 and mobile devices 1028. The remote devices enable different aspects of functionality of the system 1000, such as, but not limited to entry of subject specific data, display of historical and trending data acquired by the system 1000, and machine learning. The totality of components illustrated in FIG. 10 enable the system 1000 to be used across a variety of environments such as triage, subject monitoring and remote monitoring. However, embodiments tailored for a specific environment may not include all of the components shown in FIG. 1A. For example, use of the system 1000 as a remote monitor in the field may not utilize an external monitor 1004. Likewise, when the system 1000 is used as a monitor for multiple subjects, the system may not include a mobile device 1028. The inclusion of all of the components in FIG. 1A is intended to illustrate the flexibility and adaptability of the system 1000 to be used in different environments. However, regardless of environment, an element of the system 1000 that is required for all embodiments is the sensor array 900 previously described in FIGS. 9A and 9B.

The system 1000 additionally includes electronics module 1002 that provides power for the sensor array 900 and enables bidirectional communication with other system components such as, but not limited to the external monitor 1004, cloud computing systems 1006 or mobile devices 1028. Enabling the electronics module 1002 to perform such tasks are electronics module 1002 components such as, but not limited to communication module 1008, a processor 1010, memory 1012 and a power supply 1014 enclosed within an electronics module case. The electronics module 1002 includes additional components, however, the specific components included in FIG. 10 warrant discussion regarding operation of the system 1000.

In preferred embodiments the power supply 1014 provides power to the electronics module 1002 and also to the sensor array 900. Batteries, rechargeable or disposable, can be used for the power supply 1014. In order to minimize the likelihood of fluid ingress to the electronics module 1002, it may be preferable to use inductive charging for embodiments using rechargeable batteries. Other embodiments use alternatives to batteries such as, but not limited to capacitors, supercapacitors, solar cells, fuel cells and the like. The specific examples provided for the power supply 1014 should not be construed as limiting. Rather, the examples provided should be viewed as examples of portable power supplies capable of supplying the electronics module 1002 and the sensor array 900 with power for the expected life of the system 1000.

In some embodiments the processor 1010 is a custom circuit such as, but not limited to an application specific integrated circuit (ASIC) or field programmable gate array (FPGA). In other embodiments the processor 1010 is a more generic system on a chip (SoC) or system in package (SiP). In instances where an SoC or SiP is utilized, communication module 1008 and memory 1012 can be integrated within the SoC or SiP. In many embodiments the processor 1010 is in communication with the sensor array 900 receiving raw signal data from the plurality of working electrodes. In some embodiments the processor 1010 performs minimal manipulation of the raw data from the working electrodes. Examples of minimal manipulation include, but are not limited to, filtering noise and compression. In these embodiments the data from the working electrodes is transmitted to a multitude of external devices using the communication module 1008 where processing of raw data from the working electrodes is completed. Alternatively, in other embodiments the processor 1010 executes stored instructions to process the sensor data before transmitting processed data to any external devices via the communications module 1008.

In many embodiments the communication module 1008 is based on personal area network technology commonly referred to as Bluetooth low energy (BLE) or Bluetooth Smart. In other embodiments, a customized or semi-custom communication standard is utilized. However, one common trait for any communication module 1008 is the ability to securely send and receive data between at least a third party device and the electronics communication module 1002. The ability to securely transmit either raw or processed data using the communication module 1002 enables the flexibility that allows the system 1000 to be adaptable from a mobile monitor to being an integral component within a healthcare system.

In one embodiment data from the sensor array 900 is sent via the communications module 1008 to a cloud computing system 1006, also commonly referred to as “the cloud”. In other embodiments data from the sensor array 900 is transmitted via the communications module 1008 to an external monitor 1004. Clinical settings such as a hospital ward where multiple monitors display a plurality of conditions being monitored for a subject may be ideal settings for embodiments where the electronics module 1002 transmits to an external monitor 1004 or the cloud 1006. For example, with the appropriate infrastructure, data from the sensor array 900 can be transmitted in real-time to an electronic medical record stored in the cloud 1006. Alternatively, in some embodiments data can be transmitted from the external monitor 1004 to the cloud 1006 where it is stored as part of an electronic medical record.

In still other embodiments, the electronics module 1002 transmits data from the sensor array 900 to a mobile device 1028 such as, but not limited to a smartphone, a smartwatch, a portable fitness monitor/tracker, a tablet, a notebooks computer, or an aftermarket or integrated infotainment center for a vehicle. The examples of a mobile device 1028 are not intended to be construed as limiting. Rather, the examples are intended to provide guidance regarding the types of devices that can receive and/or transmit data to the electronics module 1002. Accordingly, devices that can be viewed as similar to those listed should be considered contemplated by the current disclosure. In embodiments where the mobile device 1028 include a connection to the internet, the mobile device 1028 can send data to the cloud 1006 where the data can be archived, shared with other devices, be further processed or become data to enable machine learning. Utilizing the data to enable machine learning further enables data-driven improvements such as development of algorithms that are patient or area specific, or algorithms that are applied universally across all subjects. For example, depending on how much information is provided with the data provided for machine learning, subject specific algorithms can include, but are not limited to factors such as age, race, weight, and preexisting conditions. Similarly, regardless of subject specific information, all data processed via machine learning can be utilized to improve algorithms with the goal being improved outcomes for all subjects.

Even with embodiments where additional processing is handled on either an external monitor 1004 or the cloud 1006, memory 102 can be used to store data from the sensor array 900 on the electronic module 1002. Using the memory 1012 to store data from the sensor array 900 can ensure sensor data is not lost if there are connectivity interruptions between the electronics module 1002 and the external monitor 1004, the cloud 1006 or a mobile device 1028. The memory 1012 can further be used to store program instructions for the processor 1010, or to store values for variables used by the processor 1010 to output sensor data.

In many embodiments the electronics module 1002 is removably coupled with the sensor array 900. With these embodiments, the electronics module 1002 is capable of being reused after the sensor array 900 is deemed consumed or depleted. In other embodiments, a permanent coupling is achieved after initial coupling between the electronics module 1002 and the sensor array 900. In these embodiments, the electronics module 1002 is considered disposable and is intended to be discarded after the sensor array 900 is deemed consumed. Alternatively, to reduce environmental impact, select portions of the electronics module, such as, but not limited to the power supply 1014 and communications module 1008 are recyclable. In many embodiments, initially coupling the electronics module 1002 to the sensor array 900 provides power to the electrodes and initiates the program instructions stored in either the processor 1010 or the memory 1012.

In many of these embodiments, the electronics module includes a feedback device 1013. The feedback device 1013 provides feedback regarding the status of the combined electronics module 1002 and sensor array 900. For example, in some embodiments the feedback device 1013 is a single or plurality of multicolored LEDs that blinks a first color and/or first pattern when the system is functioning within design parameters and a second color and/or second pattern if there is an error within the system. In other embodiments, the LED is a single color that uses different patterns of frequency of blinks to convey the status of the system. In still other embodiments, the feedback device 1013 includes a vibration device similar to those used in mobile devices to convey the status of the system. In still other embodiments, a piezo or other audible sound emitting device is used as the feedback device 1013.

The external monitor 1004 may include some components not found in the electronics module 1002, such as a graphic user interface (GUI) 1022 and a display 1024. Other components of the external monitor 1004, such as a communications module 1016, a processor 1018, a memory and a power supply 1026 may seem duplicative of components in the electronics module 1002, but may have different or improved capabilities or functionality. For example, while the power supply 1014 of the electronics module 1002 may be a battery, the power supply 1026 for th external monitor 1004 may include an alternating current power supply that is supplemented with a rechargeable battery to enable the external monitor 1004 to operate seamlessly between being plugged into a wall socket and being moved as a portable device until it can be eventually plugged back into a wall socket.

For purposes of this invention, the GUI 1022 further includes human interface devices that enable interaction with the GUI such as, but not limited to virtual or physical keyboards, touchscreens, joysticks, control pads and the like. Accordingly, use of the GUI 1022 in conjunction with the display 1024 enables user input to the system 1000 and further allows selection or customization of what is shown on the display 1024. The GUI 1022 in conjunction with the communication module 1016 and the communication module 1008 further enables settings on the electronics module 1002 to be manipulated or adjusted to optimize output from the system 100. Similarly, the GUI 1022 enables user input to the processor 1018 or the memory 1020 to enable input and adjust settings that are applied to data from the sensor array 900.

The system further optionally includes a mobile device 1028 having a user interface, such as, but not limited to a smartphone, a mobile phone, a smartwatch, a laptop, a tablet computing device, a pager and the like. The mobile device 1028 is configured to receive data from the electronics module 1002 via at least one of the cloud 1006, the external monitor 1004, or the electronics module 1002. In many embodiments the mobile device 1028 is in bidirectional communication with the electronics module 1002 which enables input via the user interface of the mobile device 1028 to be transmitted to the electronic module 1002. This enables a user of the mobile device 1028 to manipulate, configure, or program settings on the electronic module 1002. In some embodiments, bidirectional communication enables processing of data from the sensor array 900 on the mobile device 1028. Additionally, in embodiments where the mobile device 1028 includes a display, real time data and trends derived from the data is shown on the mobile device 1028. In embodiments where the mobile device 1028 includes at least one of an audible, tactile and visual alarm, the mobile device 1028 can be used to update users of the mobile device 1028 of the status of the subject wearing the sensor array 900. The status of the subject includes, but is not limited to whether the system 1000 is functioning properly, faults within the system 1000, or real time measurements from the sensor array 900.

Another option component within the system 1000 is the cloud 1006. Generally, the cloud 1006 is considered some type of cloud computing which can be generalized as internet based computing that proves on demand shared computing processing resources and data to computer and other internet connected devices. In some embodiments the cloud 1006 receives data from the electronics module 1002 directly. In other embodiments data from the electronics module 1002 is transmitted to the mobile device 1028 before being transmitted to the cloud 1006. In still other embodiments, the cloud 1006 receives data from the electronics module 1002 via the external monitor 1004. In still other embodiments, various permutations of communications initiated by the electronics module 1002 and transmitted between the external monitor 1004, and the mobile device 1028 results in data being transmitted to the cloud 1006.

Data received by the cloud 1006 may have already been processed by an intermediary device or can be processed on the cloud 1006 and transmitted back to the intermediary device. In some embodiments, the cloud 1006 contains electronic medical records and data from the sensor array 900 is automatically uploaded to the electronic medical record. With real time data being uploaded to the cloud, it becomes possible to apply machine learning which can further enable automatic or semi-automatic adjustments to the electronics module 1002. Automatic updating can result in changes to the programming of the electronic module 1002 without human intervention whereas semi-automatic updating would require someone to confirm changes to the programming of the electronic module 1002. In one example, the cloud 1006 enables examination of medical history such as pre-existing conditions or exposure of subjects in close proximity to each other to inhibition agents and machine learning can suggest or set thresholds and sensor sampling rates based on previous data from subjects experiencing similar conditions and timing.

The previously discussed components or elements within the system 1000 are intended to be exemplary rather than limiting. As the system 100 is intended to be flexible, components are able to be added or removed based on immediate needs. This includes enabling or disabling system components within one environment while enabling or disabling the same system components at a later point. For example, a facility utilizing the system from triage may not implement or enable communications to mobile devices 1028 while enabling communication with the cloud 1006. However, once a subject is moved from triage to a monitoring or remote monitoring environment, communication with a mobile device 1028 may be enabled.

Furthermore, “sensor” or “sensor assembly” as used herein is any device, component or combination that (1) detects/records/communicates information about an event or the presence/absence of a particular analyte, thing or property in its sensing environment, and/or (2) indicates an absolute or relative value/quantity/concentration, or rate of change, of that analyte, thing or property.

The sensor may be based on any principle and can be an electrochemical sensor, an impedance sensor, an acoustic sensor, a radiation sensor, a flow sensor, an immunosensor, or the like. For in-vivo use in medical and veterinary applications, the sensor may be used to detect, measure and/or record (1) one or more analytes, such as, but not limited to glucose, lactate, oxygen, ketone, or any other marker(s) of a disease or medical condition, and (2) one or more of properties, such as temperature, pressure, perfusion rate, hydration or pH.

The use of the sensing and infusion devices described herein are also not limited to a specific physical structure of the sensor or infusion device. For example, in a glucose sensing application, the sensor may be similar to a conventional glucose sensors that use a glucose-limiting membrane and generally based on the principles of one-dimensional diffusion, where glucose and oxygen travel in the same general direction before reacting within the enzyme layer (e.g., glucose oxidase) at the working electrode. Or the sensor can use any other non-conventional structure, based on a glucose sensor without a glucose limiting membrane and/or any structure that takes advantage of multi-dimensional diffusion.

The combined sensing/infusion devices described herein may be applied in any medical or veterinary application. This includes the treatment/management of diabetes and the development of the artificial pancreas, by having a single point of insertion for infusion and sensing that reduces trauma to the patient; the embodiments described herein would allow one or more glucose sensors to be placed within one or more infusion catheters that deliver one or more drugs/agents/infusates (e.g., glucagon and insulin). The combined sensing/infusion devices can also be used to support organ failure with sensor augmented drug delivery, by combining an infusion catheter with sensors (e.g, sensors for lactate and oxygen) and directly inserting the device in the vasculature and tissue of failing organs, thereby providing high dose, targeted therapy designed to normalize mitochondria function. Alternatively, it can also be used to monitor metabolic changes in current or former cancer patients and tailor treatment compositions based on metabolic profiling specific to a cancer type.

In many embodiments, additional features or elements can be included or added to the exemplary features described above. Alternatively, in other embodiments, fewer features or elements can be included or removed from the exemplary features described above. In still other embodiments, where possible, combination of elements or features discussed or disclosed incongruously may be combined together in a single embodiment rather than discreetly as in the exemplary discussion. Accordingly, while the description above refers to particular embodiments of the invention, it will be understood that many modifications or combinations of the disclosed embodiments may be made without departing from the spirit thereof. The presently disclosed embodiments are therefore to be considered in all respects as illustrative and not restrictive.

1. A working electrode configured to detect exposure to a compound of interest, comprising:
a substrate being electrically conductive;
an electrode surface disposed on the substrate;
a first transport material being disposed over the electrode surface;
a first reactive chemistry disposed substantially over the electrode surface, the first reactive chemistry selected to react with a byproduct generated from the compound of interest, the reaction between the first reactive chemistry and the byproduct generates an intermediary that is electrochemically reduced on the electrode surface to generate an electrical signal being representative of the presence of the byproduct,
wherein detection of the compound of interest is determined by a decrease in the electrical signal.

2. The working electrode of claim 1, further comprising:
masking having apertures, the masking being placed over the substrate, wherein the electrode surface is disposed within the apertures in the masking.

3. The working electrode of claim 2, wherein the first reactive chemistry is disposed directly over the electrode surface.

4. The working electrode of claim 2, wherein the first reactive chemistry is disposed over the electrode surface and a portion of the masking.

5. The working electrode of claim 3, wherein the first transport material is disposed over an entirety of the substrate, an entirety of the electrode surface and the first reactive chemistry.

6. The working electrode of claim 3, wherein the first transport material is disposed over at least a portion of the substrate, at least a portion of the electrode surface, and the first reactive chemistry.

7. The working electrode of claim 6, wherein a second transport material is disposed over at least a portion of the first transport material.

8. The working electrode of claim 6, wherein the second transport material is disposed over an entirety of the first transport material.

9. The working electrode of claim 2, wherein the first transport material is disposed over an entirety of the substrate and the electrode surface.

10. The working electrode of claim 9, wherein the first reactive chemistry is disposed on top of the first transport material, the first reactive chemistry further being disposed substantially over the electrode surface.

11. The working electrode of claim 10, wherein the first reactive chemistry shadows the electrode surface.

12. The working electrode of claim 11, further comprising:
a second transport material being disposed on top of the first reactive chemistry.

13. The working electrode of claim 12, wherein the second transport material is further disposed over and covers the substrate and the first transport material.

14. The working electrode of claim 12, wherein the second transport material covers the substrate but does completely cover the first transport material.

15. The working electrode of claim 1, wherein the first reactive chemistry is choline oxidase.

16. The working electrode of claim 15, wherein the compound of interest is acetylcholinesterase.

17. The working electrode of claim 16, wherein the byproduct generated from the compound of interest and reactive chemistry is choline.

18. The working electrode of claim 17, wherein the intermediary is hydrogen peroxide.

19. The working electrode of claim 18, wherein the first transport material is a hydrogel.

20. The working electrode of claim 19, wherein the second transport material is silicone.
